(19) United States
(12) Patent Application Publication
(10) Pub. No.: US 2015/0231531 A1
(43) Pub. Date: Aug. 20, 2015

(54) VANED FILTRATION MEDIA AND METHODS OF MAKING THE SAME

(71) Applicant: Essentra Porous Technologies Corp., Colonial Heights, VA (US)

(72) Inventors: Brenton D. Dillie, Colonial Heights, VA (US); Alison Kimmitz, Colonial Heights, VA (US); Thomas Harris, Colonial Heights, VA (US); Mike Spencer, Colonial Heights, VA (US)

(21) Appl. No.: 14/626,768

(22) Filed: Feb. 19, 2015

Related U.S. Application Data
(60) Provisional application No. 61/941,635, filed on Feb. 19, 2014.

(51) Int. Cl. B01D 29/03; B01D 29/01

(52) U.S. Cl. CPC B01D 29/031; B01D 29/012

(57) ABSTRACT

A filter media having at least one filter layer comprising a plurality of peaks and valleys and planar segments disposed between the peaks and valleys. The filter layer may be formed into a self-supporting, three-dimensional configuration without bending, folding or pleating. The filter layer has a substantially uniform cross-sectional thickness across the plurality of peaks, valleys and planar segments. The filter layer has substantially the same flow and filtration characteristics across the peaks, valleys and planar segments. The filter layer may be continuous around its entire circumference and thus may be formed without seams.

### CROSS-REFERENCE TO RELATED APPLICATIONS

This application claims the benefit under 35 U.S.C. §119(e) of U.S. Provisional Application No. 61/941,635, filed Feb. 19, 2014, the entire contents of which are incorporated by reference as if fully set forth herein.

### FIELD OF THE INVENTION

This invention relates to vaned filtration media and to methods of making the same.

### BACKGROUND

Filters are utilized in a wide range of applications. Among the persistent challenges in filter design is the filter's ability to have the characteristics of both high filter efficiency and low flow resistance. Filter efficiency refers to the percentage of particles trapped by a filter to the total amount of particles upstream of the filter. High filter efficiency is often achieved by decreasing the pore size of the filter and/or by increasing the filter thickness. Increasing filter efficiency in this manner, however, typically has the undesirable consequence of increasing flow resistance.

Filter efficiency may also be increased by increasing the filter surface area within a given volume. Pleated filters are one example of filters that are configured to maximize filter surface area and are typically formed by pleating or folding a planar filter layer. Pleated filters may be formed into a panel or in a tubular shape by joining the ends together. Oil filters are examples of pleated filters which are formed in a tubular or cylindrical shape.

Pleated filter media have a number of shortcomings. One shortcoming is that the bend regions of the pleated filters are typically thicker due to the stretching on one side and compaction on the opposing side that results from pleating or folding a planar material. This gives rise to the creation of flow and filtration properties at the bend regions of the pleated filter layer that are different from planar regions of the pleated filters. These differences may be more pronounced with filter layers having increased thicknesses.

Another shortcoming particular to pleated filters that are formed into a tubular shape is the presence of a seam that is created by joining the opposing ends of a planar filter layer. The presence of seams negatively impact the performance of a filter by altering its filtration characteristics. Because seams are typically bonded together by adhesives, the seams render the filter non-porous and therefore reduce the filter's effective filtration surface area. The negative impact of a seam is greater for smaller pleated filters, as the seam will occupy a proportionally greater surface area of smaller pleated filters. Seams are also a point of weakness in a filter and may partially or totally fail.

### BRIEF SUMMARY

The vaned filter media formed from polymeric fibers disclosed herein provide certain of the advantages associated with a traditional pleated filter but without the disadvantages of having a seam and localized non-uniformity in composition and flow characteristics typically observed in the fold regions of the traditional pleated filter.

In one embodiment, a filter media is provided. The filter media may comprise at least one filter layer comprising a plurality of peaks and valleys and planar segments disposed between the peaks and valleys. The filter layer may be formed into a self-supporting, three-dimensional configuration without bending, folding or pleating. The filter layer may have a substantially uniform cross-sectional thickness across the plurality of peaks, valleys and planar segments. The filter layer may have substantially the same flow and filtration characteristics across the peaks, valleys and planar segments.

In accordance with a first aspect, the at least one filter layer may be formed from one or more thermoplastic fibrous material.

In accordance with a second aspect, the thermoplastic fibrous material may be formed from one or a combination of fibers comprising polyolefin, polyester, polyurethane, polyamide, polyethylene, low density polyethylene, polypropylene, polyethylene terephthalate, polybutylene terephthalate, nylon, and co-polymers thereof.

In accordance with a third aspect, the at least one filter layer may comprise a plurality of filter layers.

In accordance with a fourth aspect, the plurality of filter layers comprises at least one microfiber layer and at least one nanofiber layer.

In accordance with a fifth aspect, the plurality of filter layers comprise a first fiber layer and a second fiber layer. The first fiber layer comprises a first plurality of polymeric fibers bonded to each other at spaced apart contact points. The first plurality of polymeric fibers have diameters greater than one micron and collectively define a first plurality of interconnected interstitial spaces providing tortuous fluid flow paths and a first set of flow characteristics through a first portion of the first fiber layer. The second fiber layer may be adhered to the first fiber layer and comprises a second plurality of polymeric fibers bonded to each other at spaced apart contact points. The second plurality of polymeric fibers have diameters greater than one micron and collectively defining a second plurality of interconnected interstitial spaces providing tortuous fluid flow paths and a second set of flow characteristics through a first portion of the second fiber layer.

In accordance with a sixth aspect, at least a portion of the polymeric fibers in a second portion of the first layer are bonded to at least a portion of the polymeric fibers in a second portion of the second layer to form an interface zone comprising fibers of both the first and second fiber layers, the fibers collectively defining a third plurality of interstitial spaces.

In accordance with a seventh aspect, a plurality of nanofibers may be disposed within the third plurality of interstitial spaces in the interface zone. The first portion of the first fiber layer and the first portion of the second fiber layer are free of nanofibers.

In accordance with a eighth aspect the interface zone has a third set of flow characteristics that may be different from the first set of flow characteristics and the second set of flow characteristics.

In another embodiment, a filter media is provided. The filter media comprises a filter layer having a plurality of radial vanes formed from a plurality of peaks and valleys. The plurality of peaks define an outer cylindrical diameter and the plurality of valleys define an inner cylindrical diameter. The filter layer forms a substantially tubular configuration. The vanes of the filter layer are not formed from bending, folding or pleating. The filter layer does not comprise seams and may be continuous around its entire circumference.

In accordance with a first aspect, the filter layer comprises a plurality of planar segments disposed between the plurality of peaks and valleys.

In accordance with a second aspect, the filter layer has substantially the same flow and filtration characteristics across the peaks, valleys and planar segments.

In accordance with a third aspect, the filter layer has a substantially uniform cross-sectional thickness across the plurality of peaks, valleys and the planar segments.

In accordance with a fourth aspect, the filter layer does not comprise adhesives to form the substantially tubular configuration.

In accordance with a fifth aspect, the outer cylindrical diameter may be about 3-10 inches and the inner cylindrical diameter may be about 2-9 inches.

In accordance with a sixth aspect, the filter media comprises about 5 to 10 peaks per inch.

In a further embodiment, a method for manufacturing a three-dimensional, self-supporting filter media is provided. The method comprises providing a forming die. The forming die comprises a peripheral die wall enclosing a cavity and a mandrel. The peripheral die wall defines a first set of vanes and the mandrel comprises a peripheral mandrel wall defining a second set of vanes corresponding in number to the first set of vanes. The mandrel may be sized such that it fits within the cavity defined by the peripheral die wall. The peripheral mandrel wall may be spaced apart from the peripheral die wall to define a filter thickness. The method further comprises feeding a first fibrous layer into the forming die between the peripheral die wall and the peripheral mandrel wall. The method further comprises heating the first fibrous layer. The method further comprises cooling the first fibrous layer to form a three-dimensional, self-supporting filter media comprising a plurality of radial vanes.

In accordance with a first aspect, the method further comprises feeding a second fibrous layer into the forming die.

In accordance with a second aspect, one of the first fibrous layer may be made of one of a plurality of microfibers or nanofibers and the second fibrous layer may be made of the other one of the plurality of microfibers or nanofibers.

In accordance with a third aspect, the forming die comprises a first section for the first fibrous layer and a second section for the second fibrous layer.

In accordance with a fourth aspect, the method further comprises feeding a previously-formed filter media or non-fibrous component into the forming die.

In accordance with a fifth aspect, feeding the previously-formed filter media or non-fibrous component into the forming die may be performed before feeding the first fibrous layer.

In accordance with a sixth aspect, the first fibrous layer may be made of one of a plurality of microfibers or nanofibers and the previously-formed filter media may be made of the other one of a plurality of microfibers or nanofibers.

Other objects, features and advantages of the described embodiments will become apparent to those skilled in the art from the following detailed description. It is to be understood, however, that the detailed description and specific examples, while indicating embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

Illustrative embodiments of the present disclosure are described herein with reference to the accompanying drawings, in which:

FIGS. 1A-1C depict the steps in creating a pleated filter media, with FIG. 1A showing a flat filter media, FIG. 1B showing the formation of the pleats by pleating or folding the flat filter media and FIG. 1C showing the formation of a tubular filter media by joining the two ends.

FIG. 2 is a cross-sectional view of a vaned filter media comprising two fibrous layers in accordance with one embodiment.

FIGS. 3A-3B depict a die and mandrel (in cross-sectional view) for forming a vaned filtration media in accordance with another embodiment.

FIG. 4 is a graph illustrating and comparing the filtration efficiencies of a multilayer filter media comprising microfiber and nanofiber layers and a filter media comprising only microfibers.

FIG. 5 is a block diagram, graphically illustrating a method of manufacturing a filter media, with at least one three dimensional bonded fiber component, in accordance with one embodiment.

FIG. 6 is a block diagram, graphically illustrating another method of manufacturing a multi-component structure, with at least one three dimensional bonded fiber component that has been surface treated.

Like numerals refer to like parts throughout the several views of the drawings.

### DETAILED DESCRIPTION OF THE EMBODIMENTS

Specific, non-limiting embodiments of the present invention will now be described with reference to the drawings. It should be understood that such embodiments are by way of example and are merely illustrative of but a small number of embodiments within the scope of the present invention. Various changes and modifications obvious to one skilled in the art to which the present invention pertains are deemed to be within the spirit, scope and contemplation of the present invention as further defined in the appended claims.

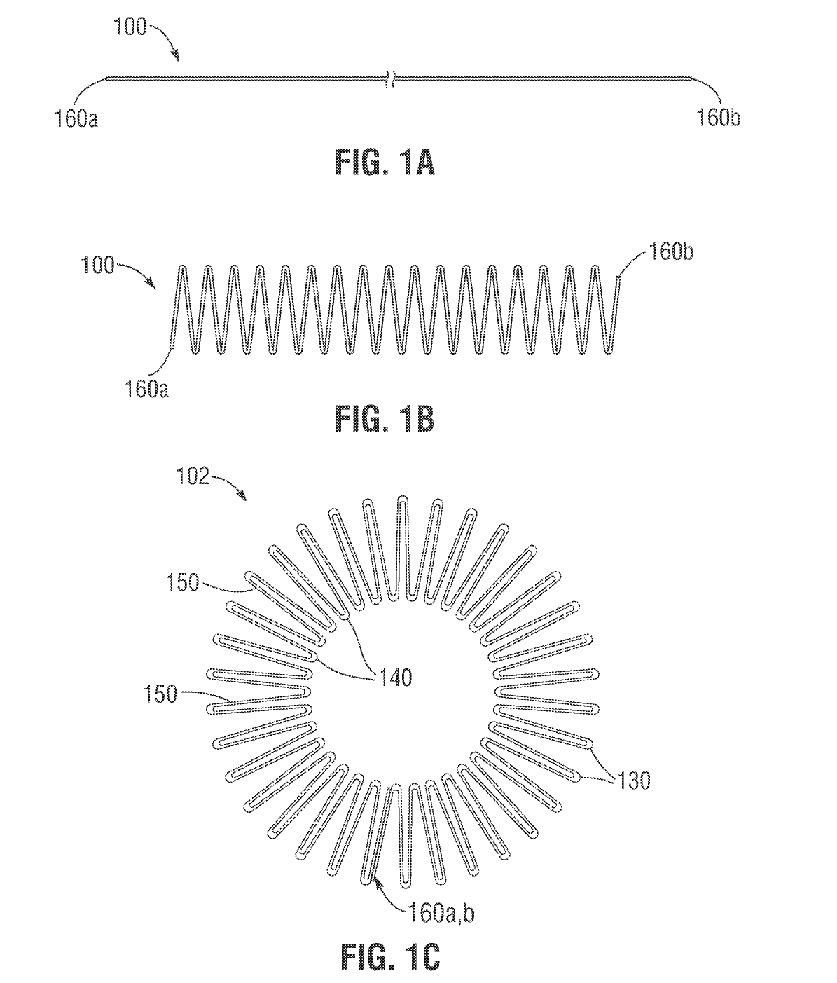

FIG. 1A-C depict the steps in creating a traditional pleated filter. A planar or flat filter layer 100 having two ends 160a, 160b (FIG. 1A) is folded along fold lines spaced apart at predetermined locations to create a plurality of pleats (FIG. 1B). The filter layer 100 may optionally be configured into a tubular configuration, with cylindrical, elliptical, or other cross-sectional configurations. FIG. 1C depicts the filter layer 100 configured into a tubular structure with a substantially circular cross-section by joining the two ends 160a, 160b together to form a seam by any number of methods, including by crimping or by using adhesives. As previously explained above, the folding of the filter layer and the presence of a seam adversely impact the filter's structural, filtration and flow characteristics. The bend regions 130, 140 of the pleated filter 100 are typically thicker than the planar regions 150 due to the stretching on one side and compaction on the opposing side that result from pleating or folding. This gives rise to the creation of flow and filtration properties at the bend regions 130, 140 of the pleated filter 100 that are different from planar regions 150 of the pleated filters. The seams by joining ends 160a,b negatively impact the performance of a filter by altering its flow and filtration characteristics and also provide a point of weakness and potentially a point of failure for the pleated filter 100.

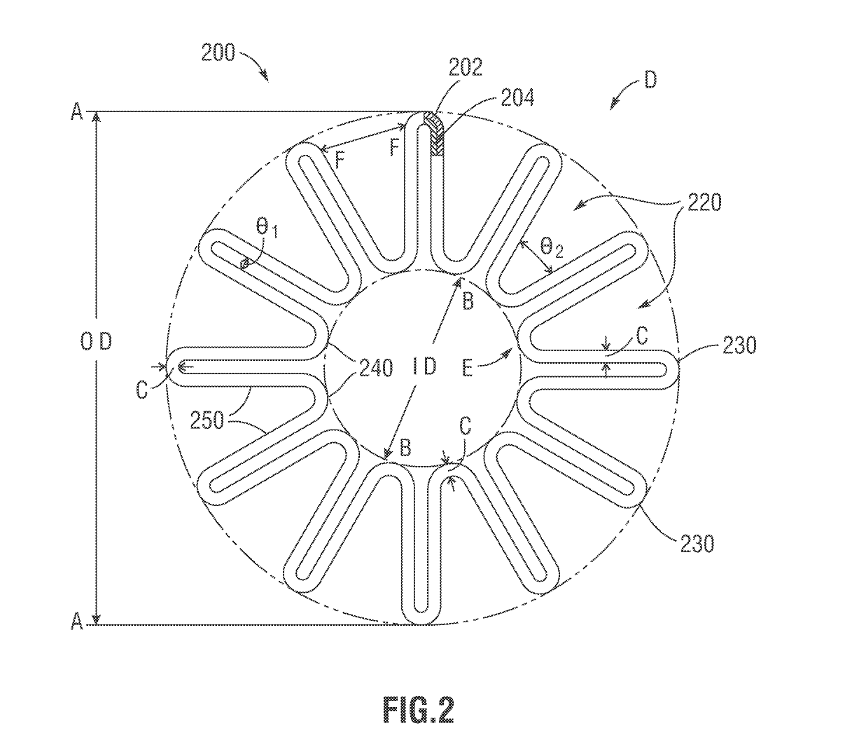

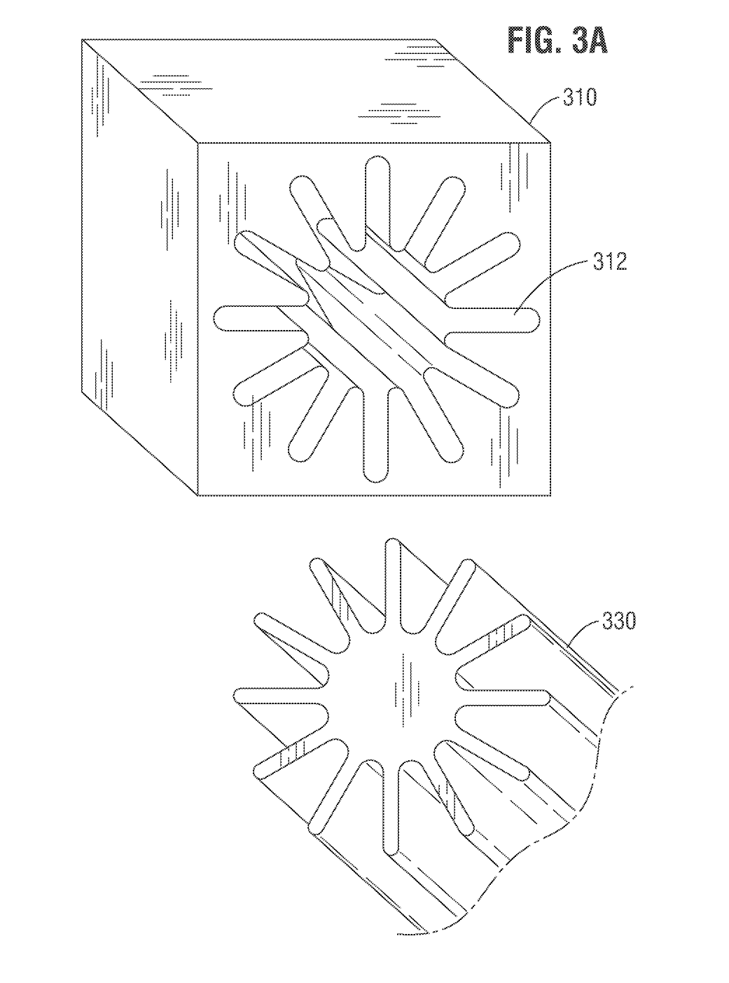

FIG. 2 depicts a vaned filter media 200 comprising peaks 230 and valleys 240 and planar segments 250 disposed between the peaks 230 and valleys 240. The vanes may comprise the peaks 230 and the planar segments 250 on opposing sides of the peaks and adjacent vanes are joined together by the valleys 240. In one embodiment, the peaks 230 and valleys 240 may each form vertices. In another embodiment, as depicted in FIGS. 2-3, the peaks 230 and valleys 240 may be curved. In a further embodiment, one of the peaks 230 and valleys 240 may form vertices and the other one of the peaks 230 and valleys 240 may be curved.

In one embodiment, the peaks 230 may be characterized as having a first angle θ₁ and the valleys 240 may be characterized as having a second angle θ₂. The first angle θ₁ and the second angle θ₂ may be the same or they may be different.

In one embodiment, the first angle θ₁ may be in the range of from about 0° to about 90°, from about 0° to about 45°, from about 1° to about 35°, from about 1° to about 25°, from about 1° to about 10°, and from about 1° to about 5°. In another embodiment, the second angle θ₂, independently of the first angle θ₁, may be in the range of from about 1° to about 90°, from about 10° to about 65°, from about 10° to about 55°, from about 10° to about 45°, from about 10° to about 35°, and from about 10° to about 25°. In another embodiment, the first angle θ₁ may be smaller than the second angle θ₂. It is observed that the vanes of the vaned filter media 200 are provided in spaced relation 220 which in large part depends on the second angle θ₂ and also the number of vanes. As the second angle θ₂ increases, the distance F-F between the peaks 230 may increase. As the number of vanes increase, the distance F-F between the peaks 230 may decrease.

In another embodiment, the peaks 230 and valleys 240 are additionally or alternatively characterized as having a radius of curvature. The peaks 230 may have a radius of curvature that is smaller than a radius of curvature for the valleys 240. As the radius of curvature for the valleys 240 increases, the distance F-F between the peaks 230 may increase.

In accordance with one embodiment, the peaks 230 and valleys 240 are not formed by bending, folding or pleating a planar filter layer to create the vanes. The vaned filter media 200 resembles a pleated filter in its configuration, but differs in that the vaned filter media 200 has substantially uniform cross-sectional thickness along the peaks 230, valleys 240 and planar segments 250 because it is not formed by bending, folding or pleating a flat or planar filter layer to create the vanes. The vaned filter media 200 also differs from the traditional pleated, tubular filter in that it is also not formed by joining the end sections of a flat or planar filter layer to create a seam. These features avoid many of the disadvantages associated with a traditional pleated filter.

Because the vaned filter media 200 is not formed by bending, folding or pleating to create the vanes, it has a substantially uniform cross-sectional thickness C-C across the plurality of peaks 230, valleys 240 and planar segments 250, as shown in FIG. 2. In one embodiment, the vaned filter media 200 has a substantially uniform cross-sectional thickness, e.g., peaks 230, valleys 240 and planar segments 250, when the variance in the cross-sectional thickness is no more than 25%, preferably no more than 15%, preferably no more than 5%, and most preferably no more than 1%.

The vaned filter media 200 also has substantially the same flow and filtration characteristics through, either from the outside in (D) or from the inside out (E), the peaks 230, valleys 240 and planar segments 250. The flow characteristics include volumetric flow rate (m³/sec) and the filtration characteristics include filter efficiency (%). In one embodiment, the vaned filter media 200 has substantially the same flow rate across the entirety of its surface, e.g., peaks 230, valleys 240 and planar segments 250 when the variance in the flow rate is no more than 25%, preferably no more than 15%, preferably no more than 5%, and most preferably no more than 1%.

In another embodiment, the vaned filter media 200 has substantially the same filter efficiency across the entirety of its surface, e.g., peaks 230, valleys 240 and planar segments 250 when the variance in the flow rate is no more than 25%, preferably no more than 15%, preferably no more than 5%, and most preferably no more than 1%.

In one embodiment, the tubular configuration of the vaned filter media 200 may be defined by peaks 230, which define a substantially circular outer periphery having an outer diameter (OD) as indicated by A-A, and valleys 240, which define a substantially circular internal periphery having an inner diameter ID as indicated by B-B. The OD may range from about 3 to about 10 inches, from about 1 to about 3 inches and from about 0.1 to about 1 inches and the ID may range from about 2 to about 9 inches, from about 0.5 to about 2.5 inches and from about 0.05 inches to about 0.9 inches.

The differences between the pleated tubular filter 102 and the vaned filter media 200 result from the different methods of manufacturing the filters. While the pleated tubular filter 102 is manufactured by pleating the filter layer 100 and joining the ends 160a, 160b to create a seam, the vaned filter media 200 may be integrally and directly formed without pleating, folding to create the vanes and without creating a seam. Thus, the physical characteristics of the vaned filter media 200 are substantially uniform along its peaks 230, valleys 240 and planar segments 250.

In one embodiment, the vaned filter media 200 may be formed from any bondable polymeric fibers and may comprise one or a plurality of fiber layers which are preferably bonded together thermally, chemically or mechanically. In one embodiment, the vaned filter media 200 may be bonded only thermally. The fiber layers may be formed from layers of thermoplastic fibrous material comprising an interconnecting network of highly dispersed and continuous and/or staple fibers bonded to each other at spaced apart points of contact. Such bonded fiber structures may be formed using a wide variety of fiber types and manufacturing methods and are described in U.S. Pat. Nos. 5,607,766; 5,620,641; 5,633,082; 6,101,181; 6,330,883; and 6,840,692 (collectively, “Bonded Fiber Structure Patents”), the entire contents of which are incorporated herein by reference in their entireties. The fiber size may range from about 0.25 microns to about 200 microns in diameter.

In one embodiment, the vaned filter media 200 comprises two or more fiber layers to produce a multi-layer filtration media. The multi-layer filtration media may comprise one or a combination of a macrofiber layer, a microfiber layer and/or a nanofiber layer. The dispersed bonded fibers of these structures define tortuous passages through the structure that can provide very high surface areas and porosity, and may be formed in a variety of sizes and shapes. The polymer materials that can be used to form the fibers may include, but are not limited to, polyolefins, polyesters, polyurethanes, polyamides, and copolymers thereof. Particular materials include polyethylene, low density polyethylene, polypropylene, polyethylene terephthalate, polybutylene terephthalate, and nylon.

In one embodiment, the vaned filter media 200 may be formed from multiple microfiber layers or from a combination of one or more microfiber layers and one or more nanofiber layers. Such multi-layer media are described in U.S. Pat. No. 8,939,295, issued Jan. 27, 2015, the entire contents of which are incorporated herein by reference. In one embodiment, nanofibers refers fibers having an average diameter of about 1 micron or less and microfibers refers to fibers having an average diameter of greater than about 1 micron to about 100 microns. Nanofibers may be produced having diameters below about 500 nanometers using electro-spinning techniques.

Referring again to FIG. 2, the vaned filter media 200 is depicted as comprising two fibrous layers 202 and 204. It is understood that the vaned filter media 200 may comprise more than two fibrous layers and any number of vanes as required by the particular filtration application and filtration characteristics desired. In one embodiment, one of the layers 202, 204 may be formed from nanofibers and the other one of the layers 202, 204 may be formed from microfibers. The microfiber layer may be carded, air laid, wet laid, melt blown, or other non-woven construction. The fibers may be mono-component or multi-component and may be bonded to one another by thermal or chemical means to impart strength to the non-woven structure. In a particular embodiment, one or both of the layers 202, 204 may be carded, through air bonded, non-woven structure comprising sheath-core bicomponent fibers. An exemplary bicomponent fiber that may be used includes one having a polyethylene sheath and a polypropylene core. The thickness of the nanofiber layer may range from about 0.25 nanometers to about 10 millimeters.

The vaned filter media 200 may comprise a plurality of different layers to provide gradient structures having different filtration properties at different depths. The layers can, for example, be arranged so that a first layer through which fluid is to be flowed (i.e., a challenge layer) may be formed with a first set of filtration characteristics and a second layer downstream of the first layer may be formed with a second set of filtration characteristics. The first layer may, for example, consist exclusively of microfibers, while the second layer may comprise nanofibers, or vice versa. In one embodiment, the nanofiber layer may be protected by one or more layers of larger, reinforcement fibers which will serve to mechanically protect the thin, fragile nature of the nanofibers. Filtration characteristics include volumetric flow rate (m³/sec), which represents the difference in pressure between two points and filtration efficiency (% particles trapped by a filter).

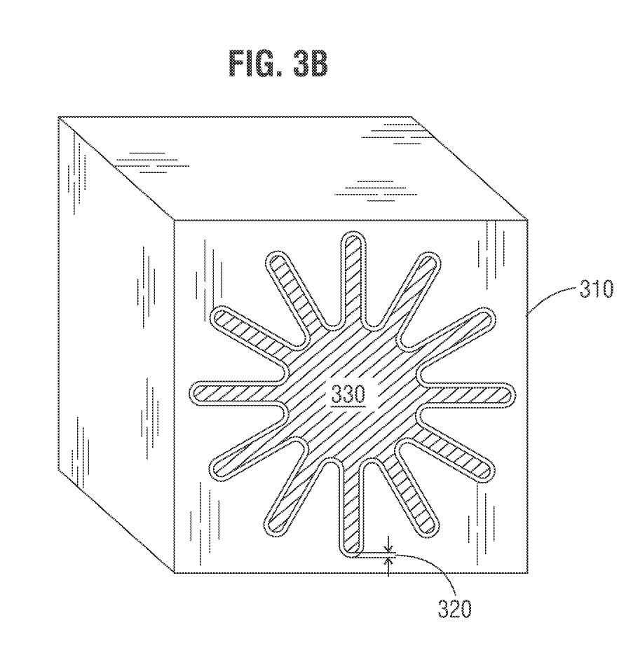

FIG. 4 compares the filter efficiency of a seamless vaned filter media with a nanofiber layer and a seamless vaned filter media without a nanofiber layer. As can be observed, the inclusion of a nanofiber layer increases the filtration efficiency. The vaned filter media without the nanofiber layer demonstrated a 44.5% filter efficiency for 6 micron particles and the vaned filter media with the nanofiber layer demonstrated a 88.8% filter efficiency for the same 6 micron particles.

In embodiments where the vaned filter media 200 comprises both microfiber and nanofiber layers, the relative arrangement of these layers may be provided in any number of ways. In one embodiment, the nanofiber layer may be located as an intermediate layer between layers 202, 204. Thus, layers 202, 204 may be comprised of a microfiber or a macrofiber and the intermediate layer may be comprised of nanofibers.

The nanofibers may be produced by electro spinning or melt blown techniques. In one embodiment, the nanofibers have a diameter in the range of about 50 nm to about 500 nm, in the range of about 100 to about 400 nm, and in the range of about 150 nm to about 250 nm. The nanofiber layer may have pore sizes in the range of from about 0.1 micron to about 15 microns or from about 1 micron to about 6 microns. The nanofibers may be formed from any suitable materials including polyvinlidene fluoride (PVDF), polyamides, polyesters, polyolefins, polyurethanes, polycarbonates, polystyrene, or other polymeric systems. The thickness of the intermediate nanofiber layer may be in the range of about 50 nm to about 5,000 nm or in the range of about 150 nm to about 1,500 nm. In one particular embodiment, the nanofibers may have diameters in the range of about 150 nm to about 250 nm and the nanofiber layer may have pore sizes in the range of about 1 micron to about 6 microns.

In accordance with one embodiment, the fibrous layers 202 and 204 may correspond to first and second fiber layers, respectively. The first fiber layer comprises a first plurality of polymeric fibers bonded to each other at spaced apart contact points. The first plurality of polymeric fibers may have diameters greater than one micron and collectively define a first plurality of interconnected interstitial spaces providing tortuous fluid flow paths and a first set of flow characteristics through a first portion of the first fiber layers 202. The second fiber layer 204 may be adhered to the first fiber layer and comprise a second plurality of polymeric fibers bonded to each other at spaced apart contact points. The second plurality of polymeric fibers may have diameters greater than one micron and collectively define a second plurality of interconnected interstitial spaces providing tortuous fluid flow paths and a second set of flow characteristics.

At least a portion of the polymeric fibers in a second portion of the first layer 202 may be bonded to at least a portion of the polymeric fibers in the second portion of the second layer 204 to form an interface zone comprising fibers of both the first and second fiber layers 202, 204 to collectively define a third plurality of interstitial spaces. In one embodiment, a plurality of nanofibers may be disposed within the third plurality of interstitial spaces in the interface zone. In one embodiment, the first portion of the first fiber layer 202 and the first portion of the second fiber layer 204 may be free of nanofibers. The interface zone may have a third set of flow characteristics that may be different from the first set of flow characteristics and the second set of flow characteristics.

It is understood that any number of layers that may be used in the multi-layer structure and that multi-layer structure is not necessarily limited to a particular configuration or arrangement or order of the macrofiber, microfiber or nanofiber layers.

In order to provide a cohesive, self-sustaining structure, the multi-layer vaned filter media 200 may require that the layers be bonded to one another, in particular to the nanofiber layer(s), preferably by thermal bonding. In another embodiment, nanofibers may be provided in the vaned filter media, not as a discrete layer, but rather the nanofibers may be interspersed between and among the fibers of the microfiber and/or macrofiber layers 202, 204.

FIGS. 3A-3B depict a forming die comprising a peripheral die wall 310 enclosing a cavity 312 and a mandrel 330 comprising a peripheral mandrel wall. The peripheral die wall 310 and the peripheral mandrel wall 330 define a set of first and second vanes, respectively. The first and second set of vanes are sized such that the mandrel 330 fits within the cavity 312 defined by the peripheral die wall 310 defined a space 320. A fibrous layer may be fed in forming die and then treated to form a porous three-dimensional, self-supporting bonded fiber structure as defined by the space 320. This space may be increased or decreased to produce a vaned filter media of increased or decreased thickness, respectively.

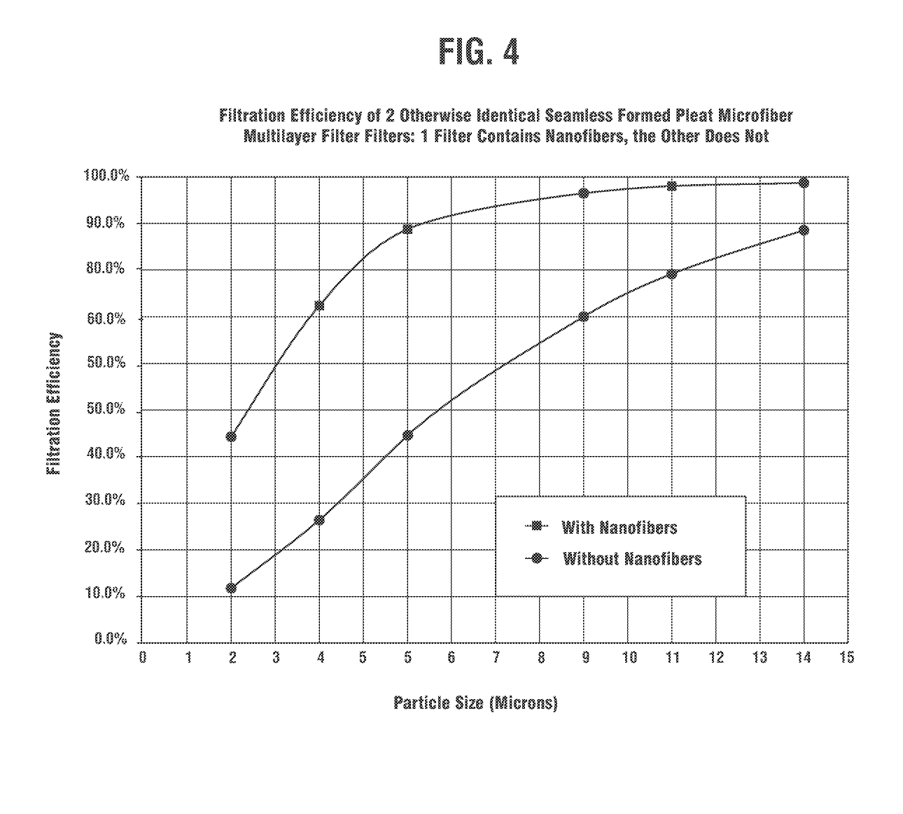

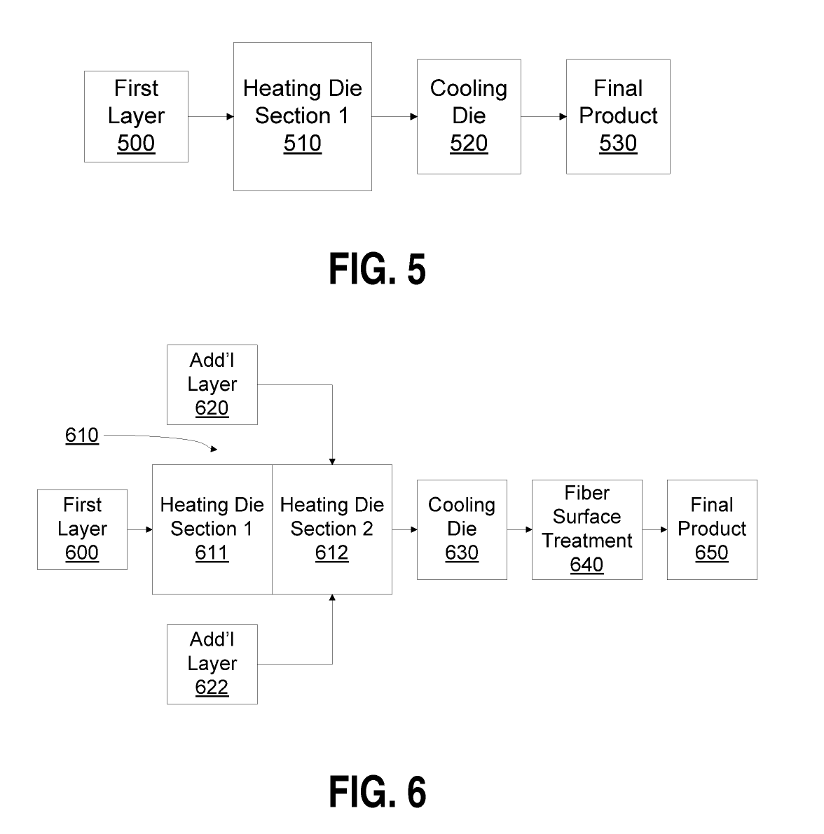

FIGS. 5-6 illustrate two alternative methods for manufacturing a three-dimensional filter media, including the vaned filter media described herein. These methods provide for the direct formation of filter media in any number of desired configurations and shapes with no significant localized variation in flow or filtration properties. Methods of manufacturing three-dimensional filter media are disclosed in U.S. Pat. No. 7,888,275, the entire disclosure of which is incorporated herein by reference.

FIG. 5 illustrates a single-stage die, single process, where materials are fed into a single-stage die and undergo a single process to form an integrally-formed, three-dimensional and self-sustaining or supporting bonded fiber structure or filter. In order to make a three-dimensional bonded fiber structure using the single-stage die, single process, a first layer 500 may be fed into a heated die 510, which causes heating of the first layer 500. In the heating die, the surface (or sheath) of fibers or bicomponent fibers soften, and where they come into contact, they begin to stick to one another. If mono-component fibers are used, a plasticizer may be used to facilitate the mono-component fibers to bond to themselves at spaced points of contact without losing their fibrous structure. Once the material is fed through the heating die 510, it may be fed into a cooling die 520. In the cooling die, the softened fiber surface (either a sheath polymer or the plasticized surface of the fiber) hardens, establishing the bonding of the fibers at points of contact. The final product 530 is then removed from the cooling die 520, and if necessary, cut to size.

FIG. 6 illustrates a multi-stage die process in which materials are fed into a multi-stage die and undergo at least one process to form an integrally formed bonded fiber structure. Integrally formed multi-component structures may be manufactured using a single, multi-stage heating die 610. The multi-stage heating die 610 may be comprised of two sections, 611, 612. The first section 611 may be sized to heat a first layer 600. This first layer 600 may enter the heating die as described above. The second section 612 may be sized to heat additional layers 620, 622. Downstream of where the first layer 600 enters the multi-stage heating die 610, additional layers 620, 622 may enter the multi-stage heating die 610 in the second section 612. All layers 600, 620, 622 may be thereby formed as a single component. This single component may then be fed into a cooling die 630 and after, if necessary, be subjected to a fiber surface treatment 640 and cut to the desired size 650. The fiber surface treatment 640 may include application of a layer to the fiber surface to render it hydrophobic, hydrophilic, oleophobic, or oleophilic, depending on the application and use of the filter.

Thus, while the resultant product may be a filter media through which liquid or gas may readily pass, it is possible by surface treatment or the use of a properly compounded sheath-forming polymer, to render the fibers hydrophobic so that, in the absence of extremely high pressures, it may function to preclude the passage of a selected liquid. Such a property may be desirable when the filter media is used, for example, as a vent filter in a pipette tip or in an intravenous solution injection system. The materials to so-treat the fiber are well known and the application of such materials to the fiber or porous element as they are formed is well within the skill of the art.

Additionally, a stream of a particulate material such as granular activated charcoal or the like (not shown) may be blown into the fibrous mass as it emanates from the die, producing excellent uniformity as a result of the turbulence caused by the high pressure air used in the melt blowing technique. Likewise, a liquid additive such as a flavorant or the like may be sprayed onto the fibrous mass in the same manner.

The discussion above reflects a specific simple process for the formation of an isotropic or anisotropic three dimensional bonded fiber structure according to various embodiments of the invention. Variations in the process, including the type of die used and the order of the manufacturing steps may occur, and are discussed below.

The manufacture of self-sustaining three-dimensional multi-component structures using both the single-stage heating die 510 and the multi-stage heating die 610 can be modified by varying the fiber type used in the layers. For example, each layer of layers fed into the heating dies may or may not be of the same characteristics (e.g., fiber core material, fiber sheath material, fiber length, finishes, loading, density (or basis weight) of the feed layer, etc.). Varying these characteristics of the component fibers may accordingly vary the characteristics of the final product.

Substantially isotropic multi-component fibrous structures may be obtained by feeding layers 500 of the same characteristics into the single-stage heating die 510 at the same time. Because each of the layers 500 are heated and cooled simultaneously, the interface that exists between the layers may be less discernible and there may be considerable commingling of fibers from each component. When layers made of fibers of the same characteristics are formed into self-sustaining three dimensional fibrous structures in a multi-stage heating die 610, the interface between layers 600, 610, 620 formed at different die stages may be more discernible.

However, when fibers of the same characteristics are formed integral to an existing component of identical fiber characteristics, the interface between components may be discernible. This interface may be characterized as having a slight change in the density of the finished component at the interface due to a smaller amount of intermingling fibers from each component. In other words, because one portion of the finished multi-component structure was formed and cooled previously, it may not have any loose fibers that may bond with fibers from the incoming component. Therefore, the interface between the components formed at different times may have a slight density difference.

The non-limiting embodiments of the present invention described and claimed herein is not to be limited in scope by the specific embodiments disclosed herein, as these embodiments are intended as illustrations of several aspects of the invention. Indeed, various modifications of the invention in addition to those shown and described herein will become apparent to those skilled in the art from the foregoing description. Such modifications are also intended to fall within the scope of the appended claims

1. A filter media comprising:
at least one filter layer comprising a plurality of peaks and valleys and planar segments disposed between the peaks and valleys, the filter layer being formed into a self-supporting, three-dimensional configuration without bending, folding or pleating;
wherein the filter layer comprises a substantially uniform cross-sectional thickness across the plurality of peaks, valleys and planar segments; and
wherein the filter layer comprises substantially the same flow and filtration characteristics across the peaks, valleys and planar segments.

2. The filter media of claim 1, wherein the at least one filter layer is formed from one or more thermoplastic fibrous material.

3. The filter media of claim 1, wherein the thermoplastic fibrous material is formed from one or a combination of fibers selected from the group consisting of: polyolefins, polyesters, polyurethanes, polyamides, polyethylenes, low density polyethylenes, polypropylenes, polyethylene terephthalates, polybutylene terephthalates, nylon, and co-polymers thereof.

4. The filter media of claim 1, wherein the at least one filter layer comprises a plurality of filter layers.

5. The filter media of claim 4, wherein the plurality of filter layers comprises at least one microfiber layer and at least one nanofiber layer.

6. The filter media of claim 4, wherein the plurality of filter layers comprises:
a first fiber layer comprising a first plurality of polymeric fibers bonded to each other at spaced apart contact points, the polymeric fibers having diameters greater than about one micron and collectively defining a first plurality of interconnected interstitial spaces providing tortuous fluid flow paths and a first set of flow characteristics through a first portion of the first fiber layer; and
a second fiber layer adhered to the first fiber layer, the second fiber layer comprising a second plurality of polymeric fibers bonded to each other at spaced apart contact points, the polymeric fibers having diameters greater than about one micron and collectively defining a second plurality of interconnected interstitial spaces providing tortuous fluid flow paths and a second set of flow characteristics through a first portion of the second fiber layer.

7. The filter media of claim 6, wherein at least a portion of the polymeric fibers in a second portion of the first layer are bonded to at least a portion of the polymeric fibers in a second portion of the second layer to form an interface zone comprising fibers of both the first and second fiber layers, the fibers collectively defining a third plurality of interstitial spaces.

8. The filter media of claim 7, wherein a plurality of nanofibers is disposed within the third plurality of interstitial spaces in the interface zone and wherein the first portion of the first fiber layer and the first portion of the second fiber layer are free of nanofibers.

9. The filter media of claim 7, wherein the interface zone has a third set of flow characteristics that is different from the first set of flow characteristics and the second set of flow characteristics.

10. A filter media comprising:
a filter layer comprising a plurality of radial vanes formed from a plurality of peaks and valleys, the plurality of peaks defining an outer cylindrical diameter and the plurality of valleys defining an inner cylindrical diameter, the filter layer forming a substantially tubular configuration;
wherein the vanes of the filter layer are not formed from bending, folding or pleating; and
wherein the filter layer does not comprise seams and is continuous around its entire circumference.

11. The filter media of claim 10, wherein the filter layer comprises a plurality of planar segments disposed between the plurality of peaks and valleys.

12. The filter media of claim 11, wherein the filter layer comprises substantially the same flow and filtration characteristics across the peaks, valleys and planar segments.

13. The filter media of claim 11, wherein the filter layer comprises a substantially uniform cross-sectional thickness across the plurality of peaks, valleys and the planar segments.

14. The filter media of claim 10, wherein the filter layer does not comprise adhesives to form the substantially tubular configuration.

15. The filter media of claim 10, wherein the outer cylindrical diameter is about 3-10 inches and the inner cylindrical diameter is about 2-9 inches.

16. The filter media of claim 10, wherein the filter media comprises about 5 to 10 peaks per inch.

17. A method for manufacturing a three-dimensional, self-supporting filter media comprising:
providing a forming die comprising:
a peripheral die wall enclosing a cavity, the peripheral die wall defining a first set of vanes; and
a mandrel comprising a peripheral mandrel wall defining a second set of vanes corresponding in number to the first set of vanes and sized such that the mandrel fits within the cavity defined by the peripheral die wall and the peripheral mandrel wall is spaced apart from the peripheral die wall to define a filter thickness;
feeding a first fibrous layer into the forming die between the peripheral die wall and the peripheral mandrel wall;
heating the first fibrous layer; and
cooling the first fibrous layer to form a three-dimensional, self-supporting filter media comprising a plurality of radial vanes.

18. The method of claim 17, further comprising:
feeding a second fibrous layer into the forming die.

19. The method of claim 18, wherein one of the first fibrous layer is made of one of a plurality of microfibers or nanofibers and the second fibrous layer is made of the other one of the plurality of microfibers or nanofibers.

20. The method of claim 18, wherein the forming die comprises a first section for the first fibrous layer and a second section for the second fibrous layer.

21. The method of claim 17, further comprising feeding a previously-formed filter media or non-fibrous component into the forming die.

22. The method of claim 21, wherein the feeding the previously-formed filter media or non-fibrous component into the forming die is performed before feeding the first fibrous layer.

23. The method of claim 21, wherein the first fibrous layer is made of one of a plurality of microfibers or nanofibers and the previously-formed filter media is made of the other one of a plurality of microfibers or nanofibers.

24. The method of claim 21, wherein the non-fibrous component is an adsorbent material, activated carbon, a film, a paper, or a powder.

25. The method of claim 17, further comprising treating the surface of the first fibrous layer to render it hydrophilic, hydrophobic, oleophilic, or oleophobic.
